(19) United States
(12) Patent Application Publication
(10) Pub. No.: US 2006/0228460 A1
(43) Pub. Date: Oct. 12, 2006

(54) Sliced tomato pickle and process for making same

(76) Inventor: Timothy Richard McGee, Merrillville, IN (US)

Correspondence Address: TIMOTHY RICHARD McGEE, 6210 KENTUCKY PLACE, MERRILLVILLE, IN, 46410, US

(21) Appl. No.: 11/100,926

(22) Filed: Apr. 8, 2005

(51) Int. Cl. A23L 1/212

(52) U.S. Cl. 426/615

(57) ABSTRACT

A sliced tomato pickle and a process for making such pickles. The tomato pickles of the invention are intended for use as a sandwich condiment item possessing a unique size and taste. The preparation of the pickles does not differ to any large degree from a standard pickling process, although various spice blends utilized do offer several definitive flavor variations. The tomato pickles of the invention are to be marketed to the fast food/deli industry as well as home consumption, and will create a distinctive flavor combination of a tomato and a pickle with an optimum size ideal for sandwich applications.

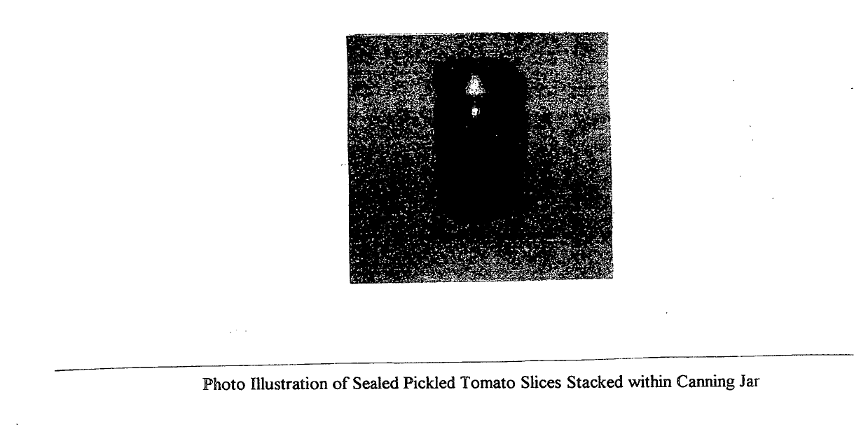

### BACKGROUND OF THE INVENTION

End of harvest season each year yields a multitude of green or under ripened tomatoes across the U.S. growing regions. This purposes a viable condiment food source alternative to merely plowing under the thousands of non-harvested tomatoes. Green tomatoes approximately 4″ in diameter are to be selected as optimum to yield the desired pickled product Slightly or fully ripened fruit may also be used if they possess adequate firmness following the canning process to be suitable for the intended sandwich use. This product is to result in a new line of refrigerated pickled tomato hamburger/sandwich slices of approximately ¼″ thickness to be marketed into the fast food industry, as well as, into the nationwide supermarket chains for consumer purchase. Several current variations of cucumber (spears, slices, stacks) and tomato (whole, quartered) are commercially available pickled to the U.S. public. No such varieties couple the flavor qualities of a tomato and a pickle with the optimum size to be useful as a sandwich condiment item for fast food restaurant and home Consumption.

### DESCRIPTION OF THE INVENTION

Green or under ripened tomatoes of the desired 4 diameter dimension are selected and horizontally cut crosswise yielding uniform ¼″ thick sliced sections. These sliced tomato sections are sorted into lots of approximately 20 and stacked into sterilized quart canning jars as illustrated in attachment photo. Depending upon the desired final flavor variation including but not limited to basic dill, garlic dill, spicy hot red pepper dill and Italian herb dill, spices to the predetermined vales detailed within the claims are introduced to the jars prior to the tomato slice stacks. A hot apple cider vinegar solution of a temperature just beneath the boiling point is added fully immersing the tomato slices. The jars are subsequently capped to seal the product and commence the pickling process. Once the jarred tomato slices are cooled to ambient temperature, the jars are transferred to a refrigerated storage facility at approximately 40 F to conserve the color and integrity of the slices. The refrigeration storage period should remain for a minimum six week time period to set in and fully impart the selected spice flavors into the final tomato sliced product. It is also desired that the jarred tomato slices remain refrigerated until sale to the consumer.

### SUMMARY OF THE INVENTION

The present invention provides a process for the production of pickled tomato slices comprising steps of selecting tomatoes, slicing tomatoes, stacking the sliced tomato sections in containers, spicing the tomato slices in a salted pickling solution, and sealing the contents to enable the pickling process to commence. Tomatoes are to be chosen either in a green or slightly ripened state. The process further includes a recommended refrigerated storage period to allow the pickling flavors to set into the tomato slices prior to sale. The pickling solution is an equal parts water and apple cider vinegar based mixture comprised of the addition of various spice combinations depending upon the actual final flavor desired which includes salt, garlic, dill, etc. The invention deals with the product of tomato slices on a per quart basis which yields approximately 20 servings per quart container. Production however need not be limited to such a small lot quantity. The invention creates a unique food condiment product which combines the flavor qualities of a pickle and a tomato with the relative benefit to the commercial sandwich market in the ability to replace two items with a single slice comprised of both tastes. The invention furthermore offers a practical alternative to the fast food, delicatessen industry nationwide in satisfying the palates of their patrons at a reduced cost and giving the general public a new taste choice for their favorite sandwich entree.

I claim:

1) A method for processing tomatoes comprising: Selecting tomatoes, Slicing the tomatoes into a desired thickness, Spicing and salting the tomatoes in a solution of (a pickling solution of water, vinegar, etc.), Stacking the tomatoes into sterilized containers to enable a pickling process, and Storing under refrigeration final tomato pickled product prior to sale.

2) The method of claim 1 wherein the tomatoes are harvested green or slightly under ripened of an approximate 4″ diameter dimension with allowable variation plus or minus to a quarter of an inch.

3) The method of claim 2 wherein the tomatoes are sliced in a horizontal crosswise fashion with both the upper and lower sections discarded as waste yielding only round shaped slices of an optimum 3¾″ to 4¼″ diameter size.

4) The method of claim 3 wherein these crosswise sections are sliced to about 0.25″ to 0.375″ thickness.

5) The method of claim 4 wherein approximately 20 sliced tomato sections are stacked one on top of another into sterilized quart glass canning containers pre-filled with the with the basic spice combination comprised of
about 1 tablespoon pickling salt
about 1 tablespoon mixed pickling spice
about 1 tablespoon dill seed
one fresh sprig dill weed.

6) The method of claim 5 including the step wherein the tomato slice sections are introduced into an equal parts hot apple cider vinegar and water solution of which has been heated to just beneath the boiling point of the mixture.

7) The method of claim 5 wherein the various flavor alternatives contain spices which are added into the basic spice mixture and are comprised of:
about 2 teaspoons of fresh minced garlic for the garlic dill variety—about 2 teaspoons of crushed red chili pepper for the spicy hot dill variety—about 2 teaspoons of Italian spice blend for the Italian herb dill variety.

8) The method of claim 6 wherein the filled containers are capped and cooled to ambient temperature to commence the pickling process.

9) The method of claim 8 wherein the sealed pickled tomato containers are recommended stored under refrigeration at approximately 40 F. to preserve the crispness of the tomato slices.

10) The method of claim 9 wherein the pickled containers remain stored under said refrigeration for a six week time frame to impart the various spice flavor additives into the tomato slices.
